(19) United States
(12) Patent Application Publication
(10) Pub. No.: US 2010/0319066 A1
(43) Pub. Date: Dec. 16, 2010

(54) METHOD AND APPARATUS FOR SUPPORTING SUBSCRIBER IDENTITY MODULE FEATURES USING A DONGLE

(75) Inventor: Onni Michael Berry, Kangasala (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/483,417

(22) Filed: Jun. 12, 2009

(51) Int. Cl. G06F 21/00

(52) U.S. Cl. 726/20

(57) ABSTRACT

In accordance with an example embodiment of the present invention, an apparatus comprises at least one processor and at least one memory. The at least one memory includes computer program code. Further, the at least one memory and the computer program code configured to, with the at least one processor, cause the apparatus to perform at least the following receive a service subscriber key request from an electronic device; determine a service subscriber key request from a subscriber identity module; and transmit the service subscriber key request to the electronic device.

### RELATED APPLICATIONS

This application is related to U.S. application Ser. No. 12/403,020, titled “METHOD AND APPARATUS FOR ACTIVATE AN AUTHENTICATION ON A MOBILE DEVICE”, filed Mar. 12, 2009, and PCT Application No. PCT/IB2009/005463, titled “METHOD AND APPARATUS FOR ACTIVATE AN AUTHENTICATION ON A MOBILE DEVICE”, filed May 1, 2009, which are hereby incorporated by reference in its entirety.

### TECHNICAL FIELD

The present application relates generally to support subscriber identity module features using a dongle.

### BACKGROUND

A dongle is a small piece of hardware that connects to, for example, a computer. Further, the dongle may be used to authenticate a piece of software. In this way, dongles authenticate software for a computer.

### SUMMARY

Various aspects of examples of the invention are set out in the claims.

According to a first aspect of the present invention, an apparatus comprises at least one processor and at least one memory. The at least one memory includes computer program code. Further, the at least one memory and the computer program code configured to, with the at least one processor, cause the apparatus to perform at least the following receive a service subscriber key request from an electronic device; determine a service subscriber key request from a subscriber identity module; and transmit the service subscriber key request to the electronic device.

According to a second aspect of the present invention, a method comprises receiving a service subscriber key request from an electronic device; determining a service subscriber key request from a subscriber identity module; and transmitting the service subscriber key request to the electronic device.

### BRIEF DESCRIPTION OF THE DRAWINGS

For a more complete understanding of example embodiments of the present invention, reference is now made to the following descriptions taken in connection with the accompanying drawings in which:

FIG. 1 is a block diagram depicting an electronic device operating in accordance with an example embodiment of the invention;

FIG. 2 is block diagram depicting an electronic device and a dongle operating in accordance with an example embodiment of the invention;

FIG. 3 is block diagram depicting a dongle operating in accordance with an example embodiment of the invention;

FIG. 4 is a flow diagram illustrating an example method for transmitting a service subscriber key in accordance with an example embodiment of the invention; and

FIG. 5 is block diagram depicting a dongle operating in accordance with an example embodiment of the invention;

### DETAILED DESCRIPTION OF THE DRAWINGS

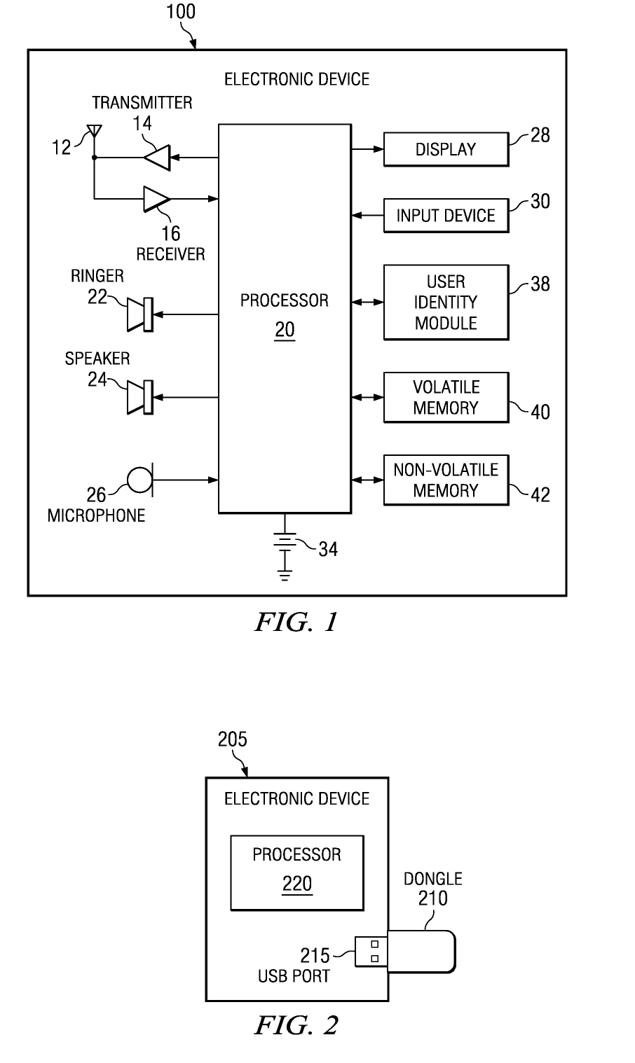

An example embodiment of the present invention and its potential advantages are understood by referring to FIGS. 1 through 5 of the drawings.

FIG. 1 is a block diagram depicting an electronic device 100 operating in accordance with an example embodiment of the invention. In an example embodiment, an electronic device 100 comprises at least one antenna 12 in communication with a transmitter 14, a receiver 16, and/or the like. The electronic device 100 may further comprise a processor 20 or other processing component. In an example embodiment, the electronic device 100 may comprises multiple processors, such as processor 20. The processor 20 may provide at least one signal to the transmitter 14 and may receive at least one signal from the receiver 16. In an embodiment, the electronic device 100 may also comprise a user interface comprising one or more input or output devices, such as a conventional earphone or speaker 24, a ringer 22, a microphone 26, a display 28, and/or the like. In an embodiment, an input device 30 comprises a mouse, a touch screen interface, a pointer, and/or the like. In an embodiment, the one or more output devices of the user interface may be coupled to the processor 20. In an example embodiment, the display 28 is a touch screen, liquid crystal display, and/or the like.

In an embodiment, the electronic device 100 may also comprise a battery 34, such as a vibrating battery pack, for powering various circuits to operate the electronic device 100. Further, the vibrating battery pack may also provide mechanical vibration as a detectable output. In an embodiment, the electronic device 100 may further comprise a user identity module (UIM) 38. In one embodiment, the UIM 38 may be a memory device comprising a processor. The UIM 38 may comprise, for example, a subscriber identity module (SIM), a universal integrated circuit card (UICC), a universal subscriber identity module (USIM), a removable user identity module (R-UIM), and/or the like. Further, the UIM 38 may store one or more information elements related to a subscriber, such as a mobile subscriber.

In an embodiment, the electronic device 100 may comprise memory. For example, the electronic device 100 may comprise volatile memory 40, such as random access memory (RAM). Volatile memory 40 may comprise a cache area for the temporary storage of data. Further, the electronic device 100 may also comprise non-volatile memory 42, which may be embedded and/or may be removable. The non-volatile memory 42 may also comprise an electrically erasable programmable read only memory (EEPROM), flash memory, and/or the like. In an alternative embodiment, the processor 20 may comprise memory. For example, the processor 20 may comprise volatile memory 40, non-volatile memory 42, and/or the like.

In an embodiment, the electronic device 100 may use memory to store any of a number of pieces of information and/or data to implement one or more features of the electronic device 100. Further, the memory may comprise an identifier, such as international mobile equipment identification (IMEI) code, capable of uniquely identifying the electronic device 100. The memory may store one or more instructions for determining cellular identification information based at least in part on the identifier. For example, the processor 20, using the stored instructions, may determine an identity, e.g., cell id identity or cell id information, of a communication with the electronic device 100.

In an embodiment, the processor 20 of the electronic device 100 may comprise circuitry for implementing audio feature, logic features, and/or the like. For example, the processor 20 may comprise a digital signal processor device, a microprocessor device, a digital to analog converter, other support circuits, and/or the like. In an embodiment, control and signal processing features of the processor 20 may be allocated between devices, such as the devices describe above, according to their respective capabilities. Further, the processor 20 may also comprise an internal voice coder and/or an internal data modem. Further still, the processor 20 may comprise features to operate one or more software programs. For example, the processor 20 may be capable of operating a software program for connectivity, such as a conventional Internet browser. Further, the connectivity program may allow the electronic device 100 to transmit and receive Internet content, such as location-based content, other web page content, and/or the like. In an embodiment, the electronic device 100 may use a wireless application protocol (WAP), hypertext transfer protocol (HTTP), file transfer protocol (FTP) and/or the like to transmit and/or receive the Internet content.

In an embodiment, the electronic device 100 may be capable of operating in accordance with any of a number of a first generation communication protocol, a second generation communication protocol, a third generation communication protocol, a fourth generation communication protocol, and/or the like. For example, the electronic device 100 may be capable of operating in accordance with second generation (2G) communication protocols IS-136, time division multiple access (TDMA), global system for mobile communication (GSM). IS-95 code division multiple access (CDMA), and/or the like. Further, the electronic device 100 may be capable of operating in accordance with third-generation (3G) communication protocols, such as Universal Mobile Telecommunications System (UMTS), CDMA2000, wideband CDMA (WCDMA), time division-synchronous CDMA (TD-SCDMA), and/or the like. Further still, the electronic device 100 may also be capable of operating in accordance with 3.9 generation (3.9G) wireless communication protocols, such as Evolved Universal Terrestrial Radio Access Network (E-UTRAN) or the like, or wireless communication projects, such as long term evolution (LTE) or the like. Still further, the electronic device 100 may be capable of operating in accordance with fourth generation (4G) communication protocols.

In an alternative embodiment, the electronic device 100 may be capable of operating in accordance with a non-cellular communication mechanism. For example, the electronic device 100 may be capable of communication in a wireless local area network (WLAN), other communication networks, and/or the like. Further, the electronic device 100 may communicate in accordance with techniques, such as radio frequency (RF), infrared (IrDA), any of a number of WLAN techniques. For example, the electronic device 100 may communicate using one or more of the following WLAN techniques: IEEE 802.11, e.g., 802.11a, 802.11b, 802.11g, 802.11n, and/or the like. Further, the electronic device 100 may also communicate, via a world interoperability, to use a microwave access (WiMAX) technique, such as IEEE 802.16, and/or a wireless personal area network (WPAN) technique, such as IEEE 802.15, BlueTooth (BT), ultra wideband (UWB), and/or the like.

It should be understood that the communications protocols described above may employ the use of signals. In an example embodiment, the signals comprises signaling information in accordance with the air interface standard of the applicable cellular system, user speech, received data, user generated data, and/or the like. In an embodiment, the electronic device 100 may be capable of operating with one or more air interface standards, communication protocols, modulation types, access types, and/or the like. It should be further understood that the electronic device 100 is merely illustrative of one type of electronic device that would benefit from embodiments of the invention and, therefore, should not be taken to limit the scope of embodiments of the invention.

While embodiments of the electronic device 100 are illustrated and will be hereinafter described for purposes of example, other types of electronic devices, such as a portable digital assistant (PDA), a pager, a mobile television, a gaming device, a camera, a video recorder, an audio player, a video player, a radio, a mobile telephone, a traditional computer, a portable computer device, a global positioning system (GPS) device, a GPS navigation device, a GPS system, a mobile computer, a browsing device, an electronic book reader, a combination thereof, and/or the like, may be used. While several embodiments of the invention may be performed or used by the electronic device 100, embodiments may also be employed by a server, a service, a combination thereof, and/or the like.

FIG. 2 is block diagram depicting an electronic device 205 and a dongle 210 operating in accordance with an example embodiment of the invention. In an example embodiment, the electronic device 205 comprises a processor 220 and a universal serial bus (USB) port 215. In an alternative embodiment, the electronic device 205 comprises a parallel port, a serial port, and/or the like. In an example embodiment, the electronic device 205 is similar to the electronic device 100 of FIG. 1 and the processor 220 is similar to the processor 20 of FIG. 1. In an alternative embodiment, the electronic device 205 is different than the electronic device 100 of FIG. 1 and the processor 220 is different than the processor 20 of FIG. 1.

In an example embodiment, the processor 220 is configured to receive security data from the dongle 210. For example, the processor receives an encryption key. Further, the processor 220 is configured to activate, on the mobile device, at least one of the following: a power supply, an application, or a login based at least in part on the received security data. For example, the processor uses the encryption key to access an application on the mobile device. In an embodiment, the application will not execute without the encryption key from the dongle 210.

In an example embodiment, the electronic device 205 comprises at least one of the following: a universal serial port, a parallel port, or a serial port. In an embodiment, the electronic device 205 comprises the universal serial port coupled to the dongle 210. In an alternative embodiment, the electronic device 205 comprises the parallel port coupled to the dongle 210. In yet another alternative embodiment, the electronic device 205 comprises the serial port coupled to the dongle 210. In an embodiment, the dongle 210 is a hardware that connects to a mobile device, the electronic device 215, a computer, and/or the like. It should be understood that electronic device 205 may use any of the connections above or other connections as known in the art to communicate, e.g., request and receive, security data.

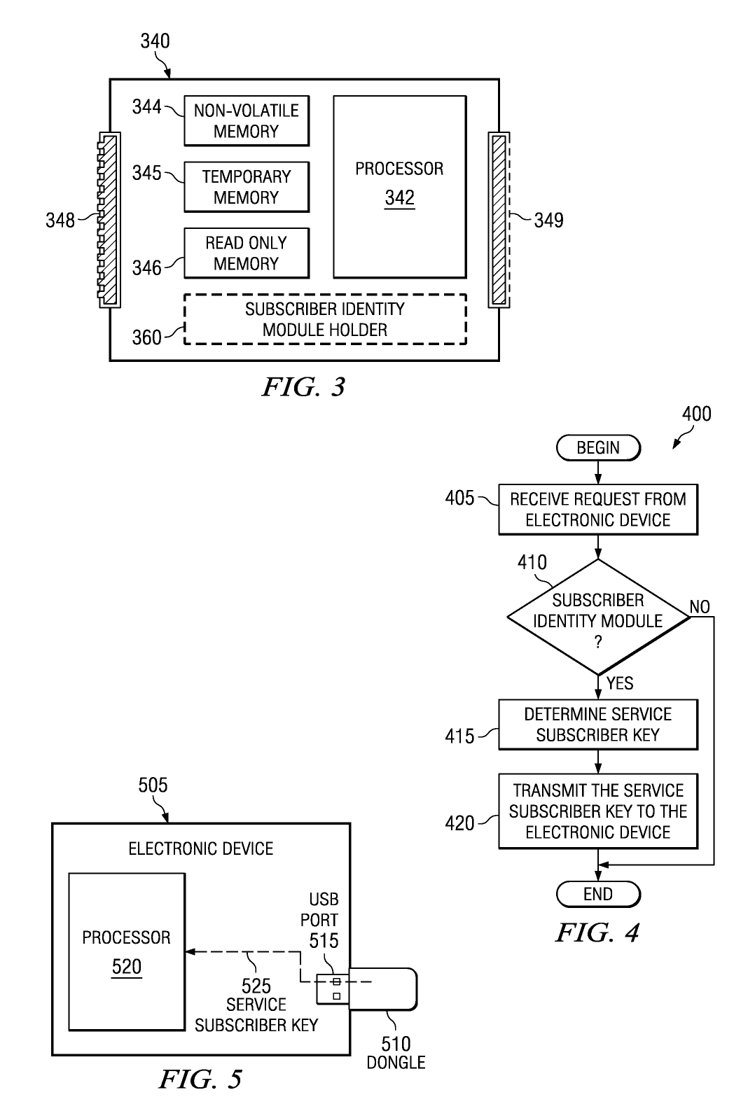

FIG. 3 is block diagram depicting a dongle 340 operating in accordance with an example embodiment of the invention. In an example embodiment, the dongle 340 is a microcontroller comprising a processor 342, a non-volatile memory 344, a temporary random access memory 345, read-only memory 346, and/or optionally a subscriber identity module holder 360. In an embodiment, the read-only memory 346 comprises program logic to cause the processor 342, such as a transmitting a service subscriber key and/or subscriber identity module information, to an electronic device, or receiving a service subscriber key from an operator, stored in the non-volatile memory 344. A possible technical effect of one or more of the example embodiments disclosed herein is transmitting a subscriber service key using a dongle.

In an embodiment, the dongle 340 also comprises a pair of connectors 348 and 349. In an embodiment, the connector 348 is a male connector adapted to connect to a parallel port of the remote computer 350. In an embodiment, the connector 349 is a female connector adapted to connect to another parallel compatible connector such as a printer cable. In an alternative embodiment, the dongle 340 may comprise a USB connector, radio-frequency identification components, or a Bluetooth wireless interface to enable transfer of a service subscriber key to an electronic device. In an embodiment, the dongle 340 may authorize a user to another device to operate on the same network and number, e.g., a multi-subscriber identity module.

In an example embodiment, at least one processor, such as processor 220 of FIG. 2, comprises at least one memory. The at least one memory may comprise computer program code. In an example embodiment, the at least one memory comprises computer program code. In an embodiment, the computer program code is configured to, with the at least one processor, cause the computer to perform at least the following receive a service subscriber key request from an electronic device; determine a service subscriber key request from a subscriber identity module; transmit the service subscriber key request to the electronic device, and receive a service subscriber key. A possible technical effect of one or more of the example embodiments disclosed herein is receiving a subscriber service key using a dongle.

In an example embodiment, the subscriber identity module holder 360 is adapted to a subscriber identity module card. In an example embodiment, a subscriber identity module card may securely store the service-subscriber key (IMSI) used, for example, to identify a subscriber on mobile telephony device, such as a mobile phone. In an embodiment, the subscriber identity module card allows users to change mobile phones by simply removing the dongle 340 and inserting the dongle 340 into another mobile phone, broadband telephony device, and/or the like. A possible technical effect of one or more of the example embodiments disclosed herein is a using a subscriber identity module holder to store a subscriber identity module in a dongle.

In an embodiment, the subscriber identity module card comprises a unique serial number, a international unique number of the mobile user (IMSI), a security authentication and a ciphering information, temporary information related to a network, a list of the services a user has access to and multiple passwords, e.g., a regular personal identification number, an unblocking personal unblocking key, and/or the like.

In an example embodiment, the subscriber identity module holder 360 is adapted to receive the subscriber identity module card of at least one of the following dimensions: a width of about 85.60 millimeter, a length of about 53.98 millimeter, a thickness of about 0.76 mm, and a width of about 25 millimeter, a length of about 15 millimeter, and a thickness of about 0.76 millimeter. In an embodiment, a subscriber identity module card may store a unique international mobile subscriber identity (IMSI) in the following format: first 3 digits represent the mobile country code (MCC), next 2 digits represent the mobile network code (MNC), and next 10 digits represent the mobile station identification number.

It should be understood that a subscriber identity module card may be a smart card, which comprises an ICC-ID number based on International Standard ISO/IEC 7812. In an embodiment, the maximum length of the visible card number is 20 characters; 19 digits are preferred, but telecommunication network operators who are already issuing Phase 1 subscriber identity module cards with an identification number length of 20 digits may retain this length. The number is composed of the following subparts: Issuer Identification number (max. 7 digits): Major Industry Identifier (MII), 2 digits, 89 for telecommunication purposes, country code, 1-3 digits, as defined by ITU-T recommendation E.164, and/or issuer identifier, variable, Individual account identification, individual account identification number, parity check digit, and/or the like.

FIG. 4 is a flow diagram illustrating an example method 400 for transmitting a service subscriber key in accordance with an example embodiment of the invention. Example method 400 may be performed by an electronic device, such as electronic device 205 of FIG. 2.

At 405, a request is received from an electronic device. In an example embodiment, a dongle, such as dongle 210 of FIG. 2, receives a request from the electronic device, such as a mobile device. For example, the mobile device requests a service subscriber key.

At 410, it is determined whether a service subscriber key exists. In an example embodiment, the dongle checks stored, for example in non-volatile memory, such as non-volatile memory 344 of FIG. 3, to determine if a service subscriber key is stored.

If at 410 it is determined that the service subscriber key exists, then at 415 the service subscriber key is determined. In an example embodiment, the dongle 340 determines the service subscriber key by performing a look-up in memory. In an alternative embodiment, the dongle determines the service subscriber key by issuing a request from an operator of the network.

At 420, the service subscriber key is transmitted to the electronic device. In an example embodiment, the dongle transmits the service subscriber key to the electronic device. In such a case, the electronic device may be used with the service subscriber key. The example method 400 ends.

If at 410 it is determined a service subscriber key does not exists, then the example method 400 ends.

FIG. 5 is block diagram depicting a dongle 510 operating in accordance with an example embodiment of the invention. In an example embodiment, an electronic device 505 comprises a processor 520 and a universal serial bus (USB) port 515. In an alternative embodiment, the electronic device 505 comprises a parallel port, a serial port, and/or the like. In an example embodiment, the electronic device 505 is communicatively coupled to a dongle 510. In an example embodiment, the electronic device 505 is similar to the electronic device 205 of FIG. 2 and the processor 520 is similar to the processor 220 of FIG. 2. In an alternative embodiment, the electronic device 505 is different than the electronic device 205 of FIG. 2 and the processor 520 is different than the processor 220 of FIG. 2.

In an example embodiment, the processor 520 of the electronic device 505 is configured to receive a service subscriber key 525 via a wireless or physical connection. For example, the processor 520 receives the service subscriber key 525 from the dongle 510.

In an example embodiment, the dongle 510 comprises at least one processor. The processor is configured to transmit the service subscriber key 525 to the electronic device 505. In an embodiment, the dongle 510 may comprise a receiver, transmitter, transceiver, and/or the like to transmit the service subscriber key 525 in a wireless manner. In such a case, the dongle 510 may be used to transmit the service subscriber key 525 to one or more devices.

Without in any way limiting the scope, interpretation, or application of the claims appearing below, a technical effect of one or more of the example embodiments disclosed herein may be transmitting a subscriber service key using a dongle. Another technical effect of one or more of the example embodiments disclosed herein may be receiving a subscriber service key using a dongle. Another technical effect of one or more of the example embodiments disclosed herein may be a using a subscriber identity module holder to store a subscriber identity module in a dongle.

Embodiments of the present invention may be implemented in software, hardware, application logic or a combination of software, hardware and application logic. The software, application logic and/or hardware may reside on an electronic device or a dongle. If desired, part of the software, application logic and/or hardware may reside on an electronic device and part of the software, application logic and/or hardware may reside on a dongle. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 3. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. A dongle, comprising:
at least one processor and at least one memory including computer program code, the at least one memory and the computer program code configured to, with the at least one processor, cause the dongle to perform at least the following:
receive a service subscriber key request from an electronic device;
determine a service subscriber key request from a subscriber identity module; and
transmit the service subscriber key request to the electronic device.

2. The dongle of claim 1 further comprising a subscriber identity module holder adapted to allow installation of a subscriber identity module card.

3. The dongle of claim 1 wherein the subscriber identity module holder is adapted to receive the subscriber identity module card of at least one of the following dimensions: a width of about 85.60 millimeter, a length of about 53.98 millimeter, a thickness of about 0.76 mm, and a width of about 25 millimeter, a length of about 15 millimeter, and a thickness of about 0.76 millimeter

4. The dongle of claim 1 further comprising subscriber identity module information stored in memory.

5. The dongle of claim 1 further comprising at least one of the following: a universal serial port, a parallel port, or a serial port.

6. The dongle of claim 5 wherein the universal serial port is coupled to an electronic device.

7. The dongle of claim 5 wherein the parallel port is coupled to an electronic device.

8. The dongle of claim 5 wherein the serial port is coupled to an electronic device.

9. The dongle of claim 1 wherein the computer program code is further configured to, with the at least one processor, cause the dongle to perform at least the following: receive a service subscriber key.

10. A method comprising:
receiving a service subscriber key request from an electronic device;
determining a service subscriber key request from a subscriber identity module; and
transmitting the service subscriber key request to the electronic device.

11. The method of claim 10 further comprising allowing installation of a subscriber identity module card in a subscriber identity module holder.

12. The method of claim 10 further comprising receiving the subscriber identity module card of at least one of the following dimensions: a width of about 85.60 millimeter, a length of about 53.98 millimeter, a thickness of about 0.76 mm, and a width of about 25 millimeter, a length of about 15 millimeter, and a thickness of about 0.76 millimeter

13. The method of claim 10 further comprising storing subscriber identity module information in memory.

14. The method of claim 10 further comprising communicating via at least one of the following: a universal serial port, a parallel port, or a serial port.

15. The method of claim 14 wherein the universal serial port is coupled to an electronic device.

16. The method of claim 14 wherein the parallel port is coupled to an electronic device.

17. The method of claim 14 wherein the serial port is coupled to an electronic device.

18. The method of claim 10 further comprising receiving a service subscriber key from an operator.

19. A computer program product comprising a computer-readable medium bearing computer program code embodied therein for use with a computer, the computer program code comprising:
code for receiving a service subscriber key request from an electronic device;
code for determining a service subscriber key request from a subscriber identity module; and
code for transmitting the service subscriber key request to the electronic device.
